(19) United States
(12) Patent Application Publication
(10) Pub. No.: US 2022/0034082 A1
(43) Pub. Date: Feb. 3, 2022

(54) INSULATION BOARD COMPRISING ENHANCED STRENGTH

(71) Applicant: Gustavo Velazquez, Raleigh, NC (US)

(72) Inventor: Gustavo Velazquez, Raleigh, NC (US)

(21) Appl. No.: 17/378,907

(22) Filed: Jul. 19, 2021

Related U.S. Application Data
(60) Provisional application No. 63/058,598, filed on Jul. 30, 2020.

(51) Int. Cl. E04B 1/80; F16L 59/02

(52) U.S. Cl. CPC E04B 1/80; E04B 2001/742; F16L 59/028

(57) ABSTRACT

The presently disclosed subject matter is directed to an insulation board for use in a wide variety of applications, such as construction of new structures. The disclosed insulation board comprises an interior foam core and an exterior support layer. The interior foam layer provides insulative characteristics to the disclosed board. In addition, the exterior support layer provides an added layer of durability, preventing or reducing the incidence of cracks, bending, and the like. The disclosed board is angled at a top edge to allow for a seamless fit during installation. The insulation board further includes a groove on the rear face that allows for the board to be easily installed during use.

### CROSS-REFERENCE TO RELATED APPLICATIONS

This patent application claims priority to U.S. Provisional Patent Application No. 63/058,598, filed Jul. 30, 2020, the entire content of which is hereby incorporated by reference herein.

### TECHNICAL FIELD

The presently disclosed subject matter relates to a multilayer insulation board comprising enhanced strength.

### BACKGROUND

Foam insulation boards are commonly used to enhance insulation of building structures. Relatively thin (about 0.25-2 inch) rectangular panels of foam board are frequently applied to the walls of building structures and/or around the lower perimeter of the structure support slab. The insulating boards generally include extruded polystyrene foam, polystyrene bead foam, and/or polyisocyanurate foam. However, prior art foam insulation boards are commonly damaged from bending, impact, or breaking. Such damage can occur through vandalism, winds, construction practices, and the like. For example, it is common for construction personnel to kneel upon foam boards while assembling walls. Such problems arise because the boards are relatively thin and have insufficient impact resistance. It would therefore be desirable to provide an insulation board material that maintains the insulative qualities of foam boards but includes enhanced strength characteristics and provides for ease of application.

### SUMMARY

In some embodiments, the presently disclosed subject matter is directed to an insulation board comprising an interior foam core and an exterior support layer surrounding the interior foam core. The insulation board includes a front face and an opposed rear face, a top edge and an opposed bottom edge, and a pair of opposed side edges. The front face comprises an angled top edge and the rear face comprises a groove defined therein.

In some embodiments, the interior foam core comprises polystyrene foam, graphite polystyrene foam, polyurethane foam, polyisocyanurate foam, polyethylene foam, polypropylene foam, polyimide foam, polyvinyl chloride foam, polyacrylic foam, epoxide foam, polyester foam, polytetrafluoroethylene foam, or combinations thereof.

In some embodiments, the foam core comprises one or more rigid foam materials.

In some embodiments, the foam core comprises one or more additives selected from the group comprising inorganic fillers, pigments, antioxidants, acid scavengers, ultraviolet absorbers, flame retardants, processing aids, stabilizers, extrusion aids, or nucleating agents.

In some embodiments, the foam core has a density of about 0.8-5 pounds/ft³.

In some embodiments, the foam core has a compressive resistance at yield of 10% deformation in psi (min) of about 5-30 in accordance with ASTM D 1621.

In some embodiments, the foam core has a flexural strength of about 20-55 psi in accordance with ASTM D790.

In some embodiments, the angled top edge is about 5-175 degrees. In some embodiments, the angled top edge is about 45 degrees.

In some embodiments, the groove contacts one edge of the rear face of the board.

In some embodiments, the rear face comprises more than one groove.

In some embodiments, the groove has a thickness of about 5-95 percent of a total thickness of the insulation board.

In some embodiments, the support layer comprises cement, acrylic, or combinations thereof.

In some embodiments, the support layer comprises about 25 weight percent cement and about 75 weight percent acrylic, based on the total weight of the support layer.

In some embodiments, the cement is Portland cement.

In some embodiments, the support layer has a thickness of about 0.1-2 inches.

In some embodiments, the insulation board comprises a yield tensile strength of at least about 5,000-10,000 psi in accordance with ASTM C1583.

In some embodiments, the presently disclosed subject matter is directed to a method of constructing the disclosed insulation board. Particularly, the method comprises forming the interior foam core through extrusion, expansion, or combinations thereof; forming an angled top edge in the foam core; forming a groove in the foam core; applying the exterior support layer such that it surrounds the interior foam core; and drying the exterior support layer.

In some embodiments, the groove, angled top edge, or both are formed through thermosetting, casting, molding cutting, impressing, or embossing.

In some embodiments, the exterior support layer is applied by spray coating, dip coating, roller coating, brush coating, casting, the use of a mold, or combinations thereof.

### BRIEF DESCRIPTION OF THE DRAWINGS

The previous summary and the following detailed descriptions are to be read in view of the drawings, which illustrate some (but not all) embodiments of the presently disclosed subject matter.

FIG. 1a is a front plan view of an insulation board in accordance with some embodiments of the presently disclosed subject matter.

FIG. 1b is a side plan view of the insulation board of FIG. 1a.

FIG. 2a is a top plan view of a foam core in accordance with some embodiments of the presently disclosed subject matter.

FIG. 2b is a bottom plan view of a foam core in accordance with some embodiments of the presently disclosed subject matter. FIG. 2c is a side plan view of a foam core in accordance with some embodiments of the presently disclosed subject matter.

FIGS. 3a-3c are fragmentary views of a top angled surface of a foam core in accordance with some embodiments of the presently disclosed subject matter.

FIGS. 4a-4d are top plan views of foam cores comprising a groove in accordance with some embodiments of the presently disclosed subject matter.

FIGS. 5a-5h are top plan views of foam boards comprising at least one groove in accordance with some embodiments of the presently disclosed subject matter.

FIG. 6 is a cross-sectional view of an insulation board comprising a foam core and an outer support layer in accordance with some embodiments of the presently disclosed subject matter.

FIG. 7a is a top plan view of an insulation board in accordance with some embodiments of the presently disclosed subject matter.

FIG. 7b is a bottom plan view of an insulation board in accordance with some embodiments of the presently disclosed subject matter.

FIG. 7c is a side plan board of an insulation board in accordance with some embodiments of the presently disclosed subject matter.

FIG. 8 is a schematic illustrating one method of making an insulation board in accordance with some embodiments of the presently disclosed subject matter.

FIGS. 9a and 9b are side plan views illustrating a method of using an insulation board in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

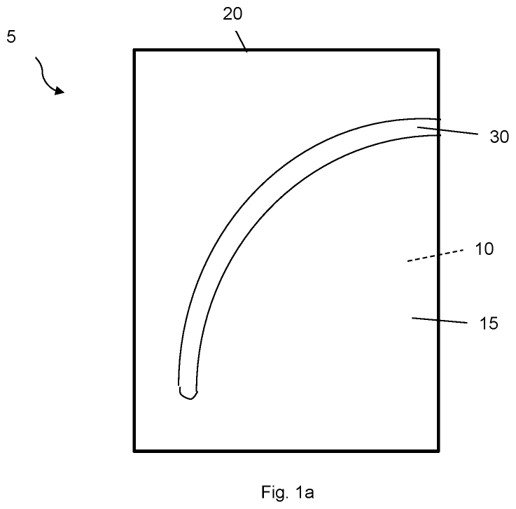

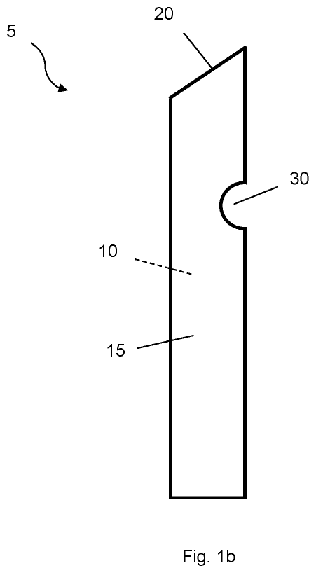

FIGS. 1a and 1b illustrate one embodiment of insulation board 5 comprising interior foam core 10 and exterior support layer 15. The term “insulation board” refers to an element commonly used in the construction of a structure (e.g., the slab of a home), providing an insulative characteristic, such as resistance to temperature change, sound dampening, and the like. The interior foam layer provides insulative characteristics to the disclosed board. As set forth in more detail below, the exterior support layer provides an added layer of durability, preventing or reducing the incidence of cracks, bending, and the like. The disclosed board is angled at top edge 20 to allow for a seamless and close fit during installation, as shown in FIG. 1b. Insulation board 5 further includes groove 30 that allows for the board to be easily installed during use. The disclosed board therefore exhibits substantially improved physical strength and abuse resistance, as well as improved ease of installation compared with prior art boards.

As set forth above, insulation board 5 comprises interior foam core 10. The term “foam” refers to foamed plastic material (also called “cellular plastics,” “cellular polymers,” “plastic foams,” or “expanded plastics). With foam materials, the density of the plastic is decreased by the presence of numerous cells disposed throughout the mass. Foam core 10 can include any desired insulation foam, such as (but not limited to) polystyrene foam, graphite polystyrene foam, polyurethane foam, polyisocyanurate foam, polyethylene foam, polypropylene foam, polyimide foam, polyvinyl chloride foam, polyacrylic foam, epoxide foam, polyester foam, polytetrafluoroethylene foam, or combinations thereof. However, it should be appreciated that the foam is not limited and can include any object formed by trapping pockets of gas in a solid.

Polystyrene foams may be derived from conventional alkenyl aromatic polymer materials. Suitable alkenyl aromatic polymer materials can include alkenyl aromatic homopolymers and copolymers of alkenyl aromatic compounds and copolymerizable ethylenically unsaturated comonomers. The alkenyl aromatic polymer material may further include minor proportions of non-alkenyl aromatic polymers. Suitable alkenyl aromatic polymers include those derived from alkenyl aromatic compounds such as styrene, alphamethylstyrene, ethylstyrene, vinyl benzene, vinyl toluene, chlorostyrene, and bromostyrene. Examples of copolymerizable compounds include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

An extruded polymer foam is generally prepared by heating a polymer material to form a plasticized or melt polymer material, incorporating therein a blowing agent to form a foamable gel, and extruding the gel through a die to form the foam product. Prior to mixing with the blowing agent, the polymer material is heated to a temperature at or above its glass transition temperature or melting point. The blowing agent may be incorporated or mixed into the melt polymer material by any means known in the art such as with an extruder, mixer, blender, or the like. The blowing agent is mixed with the melt polymer material at an elevated pressure sufficient to prevent substantial expansion of the melt polymer material and to generally disperse the blowing agent homogeneously therein. Optionally, a nucleator may be blended in the polymer melt or dry blended with the polymer material prior to plasticizing or melting. The foamable gel is typically cooled to a lower temperature to optimize physical characteristics of the foam structure. The gel may be cooled in the extruder or other mixing device or in separate coolers. The gel is then extruded or conveyed through a die of desired shape to a zone of reduced or lower pressure to form the foam structure. The zone of lower pressure is at a pressure lower than that in which the foamable gel is maintained prior to extrusion through the die. The lower pressure may be superatmospheric, subatmospheric (evacuated or vacuum), or at an atmospheric level.

Expanded bead foams may be formed by expansion of pre-expanded beads containing a blowing agent. The expanded beads may be molded at the time of expansion to form articles of various shapes. Processes for making pre-expanded beads and molded expanded bead articles are taught in Plastic Foams, Part II, Frisch and Saunders, pp. 544-585, Marcel Dekker, Inc. (1973) and Plastic Materials, Brydson, 5th ed., pp. 426-429, Butterworths (1989), which are incorporated herein by reference.

Polyurethane and polyisocyanurate foam structures are commonly made by reacting two preformulated components, commonly called the A-component and the B-component. The preformulated components comprise an isocyanate and a polyol. Polyurethane foams can be prepared by reacting the polyol and the isocyanate on a 0.7:1 to 1.1:1 equivalent basis. Polyisocyanurate foams can be advantageously prepared by reacting the polyisocyanate with a minor amount of polyol to provide about 0.10 to 0.70 hydroxyl equivalents of polyol per equivalent of polyisocyanate. Useful polyurethanes and polyisocyanurates and processes for making them are seen in U.S. Pat. No. 4,795,763, which is incorporated herein by reference.

Selection of a blowing agent is not critical to the present invention. Blowing agents useful in making the foam board will vary depending upon the composition of the foam, and can include inorganic blowing agents, organic blowing agents and chemical blowing agents. Suitable inorganic blowing agents include carbon dioxide, argon, and water. Organic blowing agents include aliphatic hydrocarbons having 1-9 carbon atoms, aliphatic alcohols having 1-3 carbon atoms, and fully and partially halogenated aliphatic hydrocarbons having 1-4 carbon atoms. Particularly useful agents include n-butane, isobutane, n-pentane, isopentane, ethanol, 1,1-difluoroethane (HFC-152a), 1,1,1,2-tetrafluoroethane (HFC-134a), ethyl chloride, 1,1-dichloro-1-fluoroethane (HCFC-141b), and 1-chloro-1,1-difluoroethane (HCFC-142b).

In some embodiments, the foam core layer can comprise one or more rigid foam materials. The term “rigid foam” refers to foams with a closed cell structure with individual cells that are discrete, such as that each closed cell is enclosed by polymeric sidewalls that minimize the flow of a gas phase from cell to cell. However, the presently disclosed subject matter is not limited and the foam board can be closed cell or open cell in accordance with ASTM D2856-87. Closed cell foams lack interconnected pores, while open cell foams include interconnected pores. Closed cell foams thus typically have higher compressive strength due to their structures compared to open cell foams. Closed cell foams are generally denser compared to open cell foams. In some embodiments, closed cell foams can be filled with a specialized gas to provide improved insulation.

In some embodiments, the foam core layer can include one or more additives to provide a desired characteristic to the foam. Suitable additives can therefore include inorganic fillers, pigments, antioxidants, acid scavengers, ultraviolet absorbers, flame retardants, processing aids, stabilizers, extrusion aids, nucleating agents, and the like. Such components are well known in the art.

Inorganic fillers add bulk to a material, and can be selected from diatomaceous earth, calcium carbonate, white carbon, talc, clay, calcium sulfate hemihydrate, anhydrous calcium sulfate, metal carbonate, metal hydroxide, alumina, kaolin, silica, mica, zeolites, glass powder, metal oxide, metal sulfate and calcium sulfite. Pigments impart a desired color and can be selected from aluminum, copper, zinc, carotenoids, chlorophylls, titanium dioxide, iron oxide, perylene pigments, azo pigments, perinone pigments, and the like. Antioxidants are compounds that inhibit oxidation and can include (but are not limited to) thiols, ascorbic acid, substituted phenols, phenylenediamine derivatives, and the like. Acid scavengers are added to remove or deactivate acid, and can include magnesium/aluminum hydrotalcite, metal salts of stearic acid, zinc materials, magnesium materials, aluminum materials, potassium hydroxide, organic amine, mineral alkali, and the like. Ultraviolet absorbers absorb UV rays and can be selected from hydroxyphenyl-benztriazole, hydroxyphenyl-triazine and benzophenone, p-aminobenzoic acid derivatives, salicylic acid derivatives; benzophenone derivatives, dibenzoylmethane derivatives, and the like. Flame retardants are capable of delaying the ignition of the material or suppressing or reducing the flammability of the material, and can be selected from ammonium phosphate, organic polymers, phosphorus compounds, organohalogens, magnesium hydroxide, aluminum trihydrate, huntite, hydromagnesium, triazines, guanidine, and the like. Processing aids assist in processing and can include (but are not limited to) esters, alkylnitroanilines, arylnitroanilines, hydroxyl amines, phosphites, metallic stearates, organic stearates, elastomers, polyglycol. Stabilizers are elements that stabilize a material and can include (but are not limited to) phosphorous acid, hypophosphorous acid, hydroxybenzophenone, fluorophosphate, organic acids, alkyl silicates, and the like. Extrusion aid assist in extrusion and can include nitric acid, hydrochloric acid, oxidized polyethylene, oxidized polypropylene, graphite powder, oxalic acid, tartaric acid, citric acid, glycerol, acetic acid, and the like. Suitable nucleating agents can include (but are not limited to) alkali or alkaline earth metal salts of hydrocarbon carboxylic acids, stearamide, ethylene bis stearamide, acetamide, benzamide, glycerol alkoxide salts, and the like.

The foam core can be constructed using any known method, such as (but not limited to) extrusion, expansion, and the like. See, for example, U.S. Pat. Nos. 3,422,172; 3,358,060; 3,845,184; 4,098,941; 4,146,562; and 9,174,363, the entire contents of which are hereby incorporated by reference.

In some embodiments, the foam core layer can comprise a commercial foam product, such as (but not limited to) NEOPOR® R-10 graphite polystyrene foam insulation board, available from BASF Corporation of Wyandotte, Mich. However, the presently disclosed subject matter is not limited and any foam material can be used.

In some embodiments, the foam core can have a density of about 0.8-5 pounds/ft³. Thus, the foam can have a density of about 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.6, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.6, 4.65, 4.7, 4.75, 4.8, 4.85, 4.9, 4.95, or 5 pounds/ft³. The foam density can refer to the density of the foam at the central portion of the foam and can be calculated by measuring the weight of the foam divided by the volume of the foam. In some embodiments, the foam density can be measured according to ASTM D792. All ASTMs referenced herein are incorporated by reference in their entireties. It should be appreciated that the presently disclosed subject matter also includes embodiments with a foam core density outside the range given above.

In some embodiments, the foam can have a compressive resistance at yield of 10% deformation in psi (min) of about 5-30. Thus, the foam can have a compressive resistance of at least about (or no more than about) 5, 10, 15, 20, 25, or 30. The term “compressive resistance” can refer to the ability of a material to resist external compressive forces. In some embodiments, compressive resistance can be measured in accordance with ASTM D 1621. It should be appreciated that the presently disclosed subject matter also includes embodiments with a foam core compressive resistance outside the range given above.

Foam core 10 can have a flexural strength of about 20-55 psi. Thus, the core can have a flexural strength of at least about (or no more than about) 20, 25, 30, 35, 40, 45, 50, or 55 psi. The term “flexural strength” refers to the ability of the foam core to bend without breaking. In some embodiments, the flexural strength can be determined using ASTM D790. It should be appreciated that the presently disclosed subject matter also includes embodiments with a foam core flexural strength value outside the range given above.

Generally, the foam core layer acts as an insulative layer, limiting moisture and air from passing therethrough. For example, the core layer can act as a vapor retarder and/or air barrier. Specifically, the insulative quality of a material can be measured using a corresponding R value, which refers to the overall thermal resistance of a material (i.e., the measure of resistance to heat transfer). The R value can be measured using the formula:

R=t/k

In the above equation, t is thickness of the material, and k is the ratio of the heat flow per unit cross-sectional to the temperature drop per unit thickness. Foam core 10 can have a R value of about 10-50. Thus, the core can have a R value of at least about (or no more than about) 10, 15, 20, 25, 30, 35, 40, 45, or 50. However, the presently disclosed subject matter is not limited and the core layer can have an R value outside the range given above.

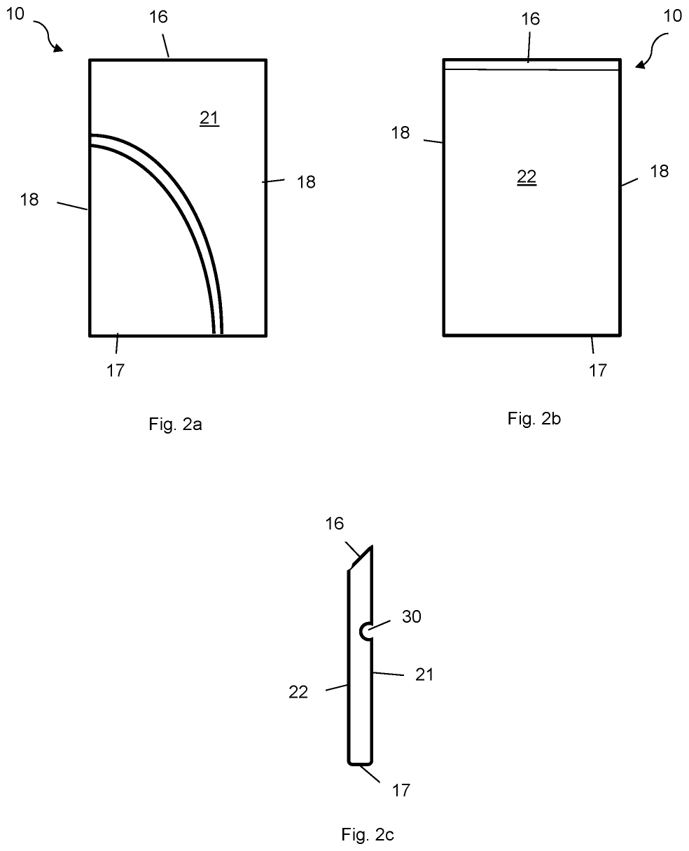

FIGS. 2a-2c illustrate one embodiment of foam core 10. As shown, the foam core can be configured in a flat and planar rectangular shape, although any shape can be used (e.g., square, rounded, oval, triangular, abstract). The foam core includes top edge 16, bottom edge 17, and opposed side edges 18. In some embodiments, the opposing side edges are about parallel with each other. The foam core further includes front face 21 and opposed rear face 22. The term “top edge” refers to the uppermost edge when the foam core is held in a user's hand. The “bottom edge” refers to the edge that opposes the top edge. The “side edges” refers to the left and right edges of the foam core when the user holds the foam core in his hand. The “front face” is the face oriented towards the user when the foam core is held in the user's hand. The “rear face” is the face oriented away from the user when held.

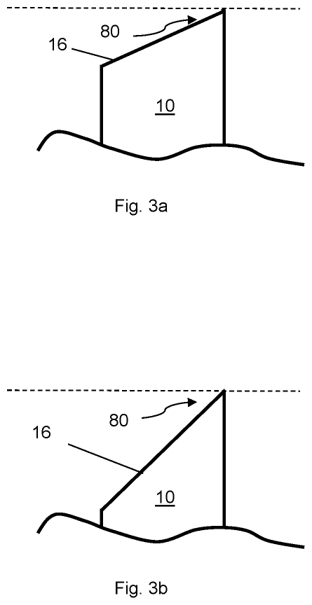

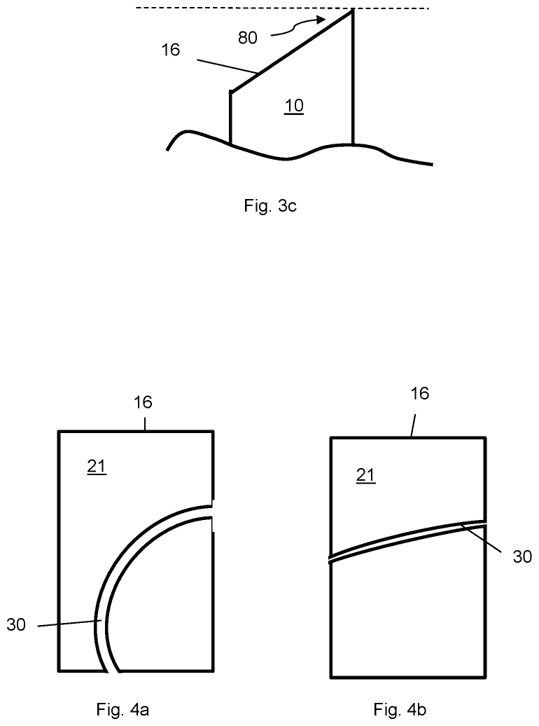

Top edge 16 of the foam core is angled on rear face 22, as shown in FIG. 2c. Particularly, angle 80 can be acute relative to the horizontal as shown in FIGS. 3a and 3b. The term “acute” refers to an angle that is less than 90 degrees. Thus, angle 80 can be at least about (or no more than about) degrees 5, 10, 15, 20, 25, 30, 35, 40, 45, 50, 55, 60, 65, 70, 75, 80, 85, or 89 degrees. In some embodiments, angle 80 can be about 45 degrees, as shown in FIG. 3c.

Angled edge 16 can be formed using any known method. For example, in some embodiments foam core 10 can be formed with the angled edge, such as through a thermoset, molding, or casting method. Alternatively, the angled edge can be formed through the use of a cutting element, such as a laser or sharp tool (e.g., knife or razor).

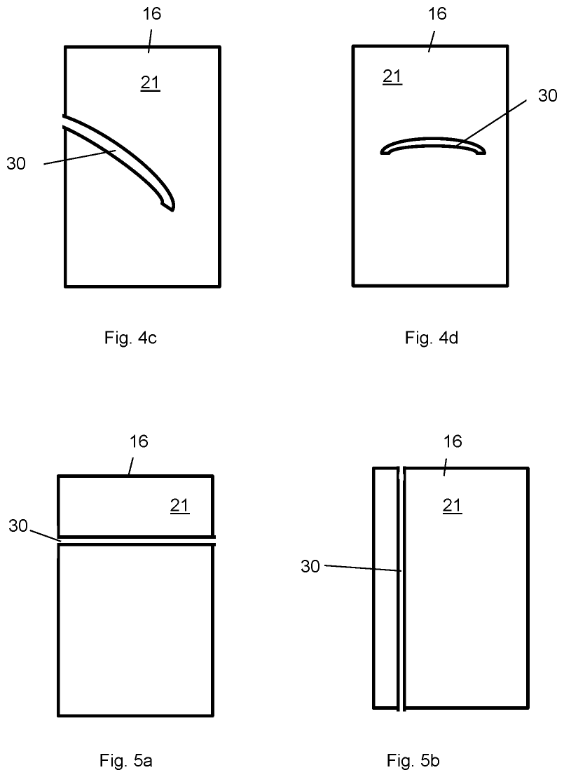

As described above, front face 21 of the foam core includes at least one groove 30 that allows the board to be attached to an adjoining structure (e.g., adjacent concrete). The term “groove” as used herein broadly refers to any elongated void area that can extend in any direction and in any manner. Groove 30 can be positioned at any desired location on front face 21. Thus, in some embodiments, the groove can extend from one side edge to a top or bottom edge of foam core 10, as shown in FIG. 4a. Alternatively, the groove can extend from one side edge to the other, as depicted in FIG. 4b. In some embodiments, the groove can extend from one edge of the board to a central endpoint on rear board face 76, as shown in FIG. 4c. In some embodiments, the groove can be positioned only within the central portion of the rear board face (e.g., not in contact with any board edges), as shown in FIG. 4d.

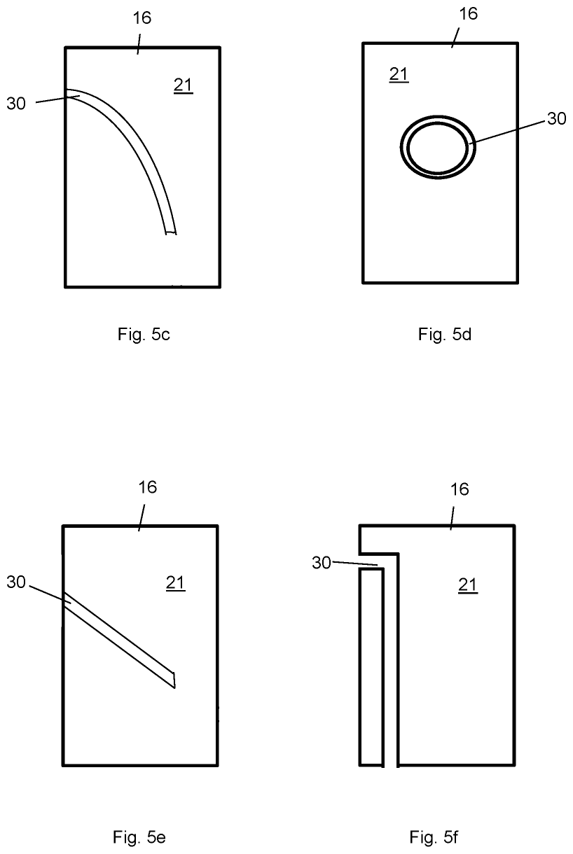

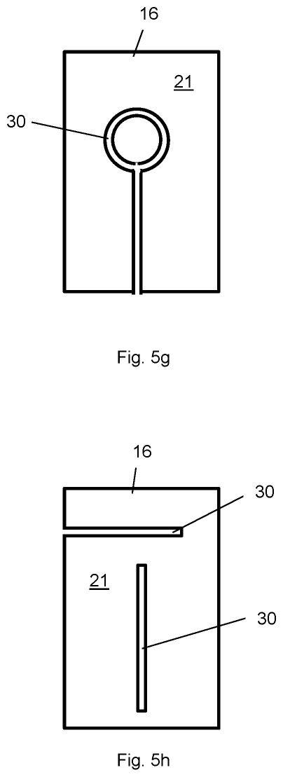

Further, the groove can be configured in any desired shape. For example, groove 30 can be linear (FIGS. 5a and 5b), curved (FIG. 5c), round (FIG. 5d), angled (FIG. 5e), or combinations thereof (FIGS. 5f and 5g). In some embodiments, the foam core can include more than one groove, as shown in FIG. 5h.

Groove 30 can extend through at least a portion of the thickness of the foam core. For example, in some embodiments, the groove can extend about 5-95 percent into the thickness of the core. Thus, if the core has a total thickness of 1 inch, the groove can extend from front face 21 into the interior of the core about 0.05 inches to a about 0.95 inches. The groove can therefore have a depth of at least about (or no more than about) 5, 10, 15, 20, 25, 30, 35, 40, 45, 50, 55, 60, 65, 70, 75, 80, 85, 90, or 95 percent of the total thickness of foam core 10.

Groove 30 can be formed using any known method. For example, in some embodiments foam core 10 can be formed with the groove, such as through a thermoset, molding, or casting method. Alternatively, the groove can be formed by cutting (e.g., with a laser or sharp implement), impressing, or embossing. For example, the groove can be impressed in the foam core using a wheel, roller, or other type of rotary device when the foam is in the most compressible or thermoformable stage (e.g., immediately or soon after extrusion).

Casting refers to a method of pouring a liquid material into a mold of desired shape. Molding refers to the shaping of an element using a rigid frame (mold). Cutting refers to the use of a sharp implement, such as a razor, knife, laser, etc. Impressing refers to the use of a stamp or other heavy item to create a desired shape in a material. Embossing refers to a stamping process for producing sunken shapes in a structure, using elements such as rollers or stamps.

As described above, board 5 comprises exterior support layer 15 surrounding at least a portion of the foam core layer. In some embodiments, the exterior support layer fully surrounds the core layer (e.g., about 100% of the exterior surface of the core layer). Alternatively, the exterior support layer can cover less than 100% of the core layer, such as at least/no more than about 50, 55, 60, 65, 70, 75, 80, 85, 90, 95, or 99%. In some embodiments, the exterior support layer is present on both front and rear faces 21, 22. Alternatively, only one of the front or rear faces can include the exterior support layer. In some embodiments one or both side edges 18 include the exterior support layer. However, in other embodiments the side edges lack the exterior support layer.

The exterior support layer can include any rigid material that provides a support feature to the foam core. Thus, exterior support layer 15 can comprise cement, acrylic, or combinations thereof. The term “cement” broadly refers to a compound that is soft when first prepared but sets or hardens. Suitable cements can be selected from hydraulic and alite cements, such as Portland cement, blended cements (e.g., Portland cement blended with fly ash, blast-furnace slag, pozzolans, etc.), masonry cement, oil well cement, natural cement, alumina cement, expansive cement, and combinations thereof. “Portland cement” refers to all cementitious compositions that have a high content of tricalcium silicate, conforming with the specification set forth in ASTM C-150, and the Portland blended comments such as those described in ASTM C-595.

The term “acrylic” refers to compounds that comprise the polymerization product of one or more acrylic monomers, such as (but not limited to) acrylates, methacrylates, (meth)acrylamides, and/or (meth)acrylic acids. In some embodiments, the acrylic can be a commercial product, such as TUFF II® 100% acrylic coating, available from Styro Industries of Rio, Wis.

In some embodiments, the support layer 15 can include a mixture of cement (e.g., Portland cement) and acrylic. For example, the support layer can comprise about 5-75 weight percent cement and about 25-95 weight percent acrylic. Thus, the support layer can comprise at least/no more than about 5, 10, 15, 20, 25, 30, 35, 40, 45, 50, 55, 60, 65, 70, or 75 weight percent cement. The support layer can further include at least/no more than about 25, 30, 35, 40, 45, 50, 55, 60, 65, 70, 75, 80, 85, 90, or 95 weight percent acrylic. For example, the support layer can comprise about 25 weight percent cement and about 75 weight percent acrylic (e.g., 100% acrylic). However, the presently disclosed subject matter is not limited and can include mixtures outside the range given above.

Support layer 15 can optionally include one or more additives to provide a desired characteristic. Suitable additives can include (but are not limited to) defoamer, dispersant, corrosion inhibitors, solubilizing agent, filler, water repellant, and the like. The additives can be present in an amount of about 0.1-5 weight percent, based on the total weight of the support layer.

Optionally, the support layer can include one or more color additives to impart a desired color scheme to board 5. It should be appreciated that any color can be used.

Advantageously, the exterior support layer provides a protective quality to board 5. Particularly, the support layer exhibits abrasion resistance, heat resistance, and provides structural strength. In this way, exterior support layer 15 provides weather, wear, and heat resistant coating that remains bonded to the foam core.

Support layer 15 can have any desired thickness, such as about 0.01-2 inches. Thus, the support layer can have a thickness of at least about (or no more than about) 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 inches. However, the presently disclosed subject matter is not limited and the support layer can have any desired thickness, such as about 2-5-10 inches (e.g., up to about 2, 3, 4, 5, 6, 7, 8, 9, or 10 inches or more).

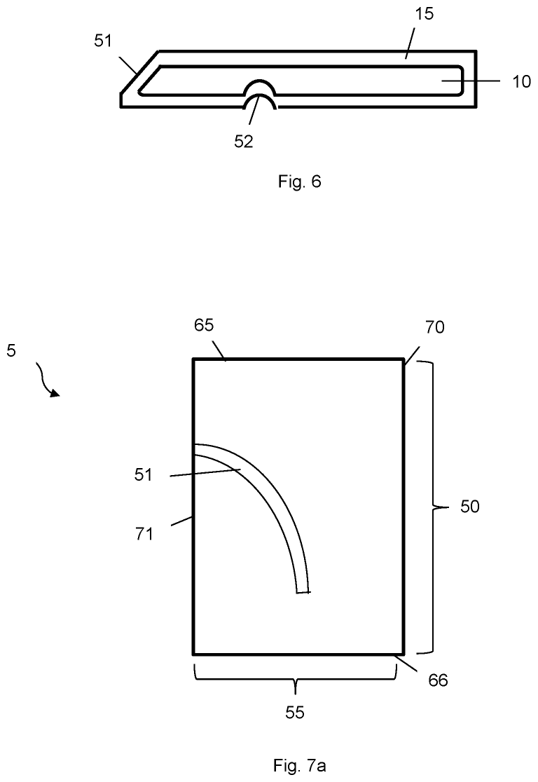

In some embodiments, the support layer is uniformly applied about the surface of foam core layer 10, as shown in FIG. 6. However, the presently disclosed subject matter also includes embodiments wherein one surface of the core layer includes a thicker support layer compared to at least one other face. Angled edge 16 and groove 30 of the foam core layer are also present on the resultant foam board as angled edge 51 and groove 52. That is, the support layer forms a coating over the core layer, such that the groove and angled top edge are also included in the final insulation board product. Therefore, the discussion above regarding the angled edge and groove of foam core 15 can equally apply to the angled edge and groove of the support layer (and final insulation board).

The support layer can be added to the foam core layer using any known method, such as (but not limited to) spray coating, dip coating, roller coating, brush coating, casting, use of a mold, and the like. Thus, in some embodiments, the support layer is sprayed onto the core layer, forming a coating that adheres directly to the foam core layer. The support layer can be formed by a single application or can be built up in layers through the user of multiple spraying cycles to form insulation board 5.

Spray coating refers to the application of a material on a base material by spraying to form a coating on the base material. Dip coating refers to the application of a material on a base by dipping the base into the application material to coat the base with the material. Roller coating and brush coating refer to the application of a material on a base material using one or more implements, such as rollers and/or brushes.

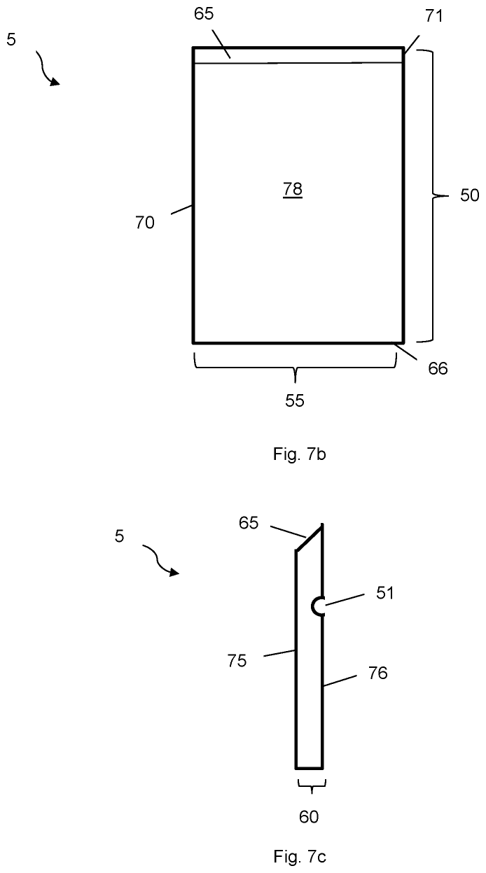

Insulation board 5 as described herein has length 50, width 55, and thickness 60, as shown in FIGS. 7a-7c. The term “length” refers to the longest vertical distance from the top edge of the board to the bottom edge of the board (e.g., from top edge 65 to bottom edge 66). The term “width” refers to the longest horizontal distance from the right edge of the board to the left edge of the board (e.g., from right edge 70 to left edge 71). The term “thickness” refers to the distance from front face 75 of the board to rear face 76. Insulation board 5 further includes front face 77 comprising angled edge 65 and groove 51 and opposing rear face 78.

Board 5 can be configured in any desired size. For example, the board can have a length and/or width of about 0.5-8 feet. Thus, the board can have a length and/or width of at least about (or no more than about) 0.5, 1, 1.5, 2, 2.5, 3, 3.5, 4, 4.5, 5, 5.5, 6, 6.5, 7, 7.5, or 8 feet. Further, the board can have a thickness of about 0.25-5 inches. Thus, the board can have a thickness of at least about (or no more than about) 0.25, 0.5, 0.75, 1, 1.25, 1.5, 1.75, 2, 2.25, 2.5, 2.75, 3, 3.25, 3.5, 3.75, 4, 4.25, 4.5, 4.75, or 5 inches. It should be appreciated that board 5 is not limited and can have a length, width and/or thickness greater or less than the ranges given herein.

Although depicted as rectangular in the Figures, it should be appreciated that the board can have any desired shape. Thus, the board can be configured in a rectangular, square, trapezoidal, round, T-shape, abstract, or any desired shape.

Board 5 exhibits improved tensile strength compared to prior art foam insulation boards. The term “tensile strength” refers to the resistance of a material to break under the application of tension. In some embodiments, the disclosed board has a yield tensile strength of at least about 5,000-10,000 psi. The yield tensile strength is the minimum stress under which a material deforms permanently. Thus, board 5 can have a yield tensile strength of at least about 5000, 6000, 7000, 8000, 9000, or 10,000 psi. In some embodiments, the tensile strength can be measured in accordance with ASTM C1583. However, the presently disclosed subject matter is not limited and the board can have a tensile strength greater or less than the range given above.

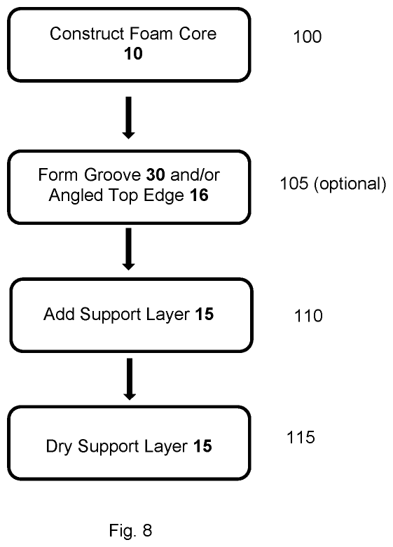

FIG. 8 is a schematic illustrating one method of making insulation board 5. Particularly, at step 100, foam core 10 is constructed using any known method (e.g., thermosetting, extrusion, injection molding, vacuum forming, casting, and the like). If groove 30 and/or angled top edge 16 are not formed in the core during construction, they are added at optional step 105 using methods well known in the art. Support layer 15 is then added to the exterior surface of foam core 10 using methods well known in the art (e.g., spraying, dipping, painting, and the like) at step 110. The support layer is then allowed to dry for a desired amount of time (e.g., 8-36 hours) at step 115. After drying, the insulation board can be shipped or used as desired in a corresponding construction project.

“Thermoset foam” refers to a cellular polymer wherein numerous gas bubbles or cells are distributed in a polymer matrix that reacts, crosslinks, and hardens into its final stage. Extrusion refers to the process of conveying a polymer melt through an extruder and forming the melt through a die that imparts a selected shape. Injection molding refers to any process where a substance or mixture of substances is forced into a mold by pressure or is melted and then poured or injected into a mold or cavity having a predetermined shape. Vacuum forming refers to a method wherein a sheet of material is heated to a forming temperature, stretched onto a single-surface mold, and forced against the mold by a vacuum.

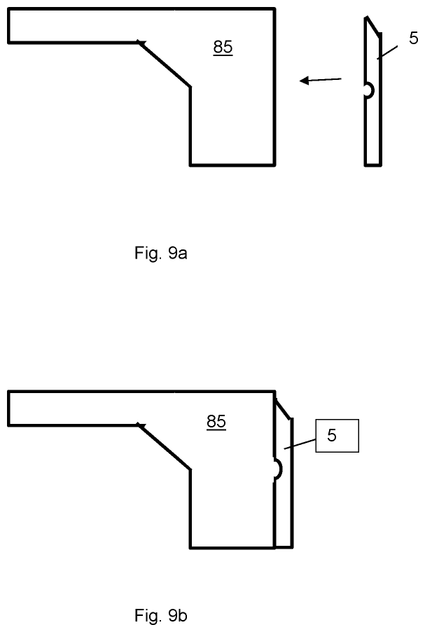

Angled top edge 65 allows board 5 to seamlessly fit into a support structure, such as (but not limited to) lower perimeter of a house. For example, FIG. 9a illustrates monolithic slab 85 such as the type used in the lower portion of a structure, such as a home. Insulative board 5 can be attached to the exterior surface of the slab (e.g., the surface viewed when looking at the home from the front). As shown in FIGS. 9a and 9b, board 5 can be positioned about the lower perimeter of a home to provide insulative and support to surrounding framework 85. Angle 65 allows the board to seamlessly fit into the surrounding construction framework 85 (e.g., an edge or lip of the board does not extend away from the structure). Thus, the board can be flush with slab 85. Board groove 51 allows the board to be attached to the slab using known techniques, such as the use of cement. In some embodiments, the insulation board can include an overhang to lock the board into correct position. The overhang can have any desired dimensions, such as (but not limited to) 0.25 inches.

Angled top edge 65 can be configured in any angle, such as about 5-175 degrees, as described above for foam top edge 16. In some embodiments, the angled top edge can be configured at about 45 degrees. Similarly, board groove 51 can be configured in any size and/or shape, as described above in the discussion of the foam groove 30. Thus, it should be appreciated that the discussion of the foam core angled edge and groove above can equally be applied to insulation board 5 and is not limited to the foam core.

The disclosed insulation board offers many advantages over the prior art. For example, support layer 15 adds a layer of protection to the core layer, allowing for the absorption of damage. As a result, board 5 provides increased strength and impact resistance compared to prior art insulation boards.

Insulation board provides insulative properties to exterior surface of a structure slab. For example, the foam core layer resists and/or prevents the influx of heat and/or moisture.

The disclosed structure is economical and can be easily constructed by those without advanced technical skills.

Insulation board 5 can be easily attached to the surrounding structure slab using groove 51, which allows for effective and reliable attachment.

In some embodiments, the structural layer of board 5 provides a fire-resistant quality to the board.

Angled edge 65 of the insulation board effectively locks the board into place when installed on a corresponding slab.

These and other advantages would be apparent after a review of the subject disclosure.

What is claimed is:

1. An insulation board comprising:
an interior foam core; and
an exterior support layer surrounding the interior foam core;
a front face and an opposed rear face, a top edge and an opposed bottom edge, and a pair of opposed side edges;
wherein the front face comprises an angled top edge; and
wherein the rear face comprises a groove defined therein.

2. The insulation board of claim 1, wherein the interior foam core comprises polystyrene foam, graphite polystyrene foam, polyurethane foam, polyisocyanurate foam, polyethylene foam, polypropylene foam, polyimide foam, polyvinyl chloride foam, polyacrylic foam, epoxide foam, polyester foam, polytetrafluoroethylene foam, or combinations thereof.

3. The insulation board of claim 1, wherein the foam core comprises one or more rigid foam materials.

4. The insulation board of claim 1, wherein the foam core comprises one or more additives selected from the group comprising inorganic fillers, pigments, antioxidants, acid scavengers, ultraviolet absorbers, flame retardants, processing aids, stabilizers, extrusion aids, or nucleating agents.

5. The insulation board of claim 1, wherein the foam core has a density of about 0.8-5 pounds/ft³.

6. The insulation board of claim 1, wherein the foam core has a compressive resistance at yield of 10% deformation in psi (min) of about 5-30 in accordance with ASTM D 1621.

7. The insulation board of claim 1, wherein the foam core has a flexural strength of about 20-55 psi in accordance with ASTM D790.

8. The insulation board of claim 1, wherein the angled top edge is about 5-85 degrees.

9. The insulation board of claim 8, wherein the angled top edge is about 45 degrees.

10. The insulation board of claim 1, wherein the groove contacts one edge of the rear face of the board.

11. The insulation board of claim 1, wherein the rear face comprises more than one groove.

12. The insulation board of claim 1, wherein the groove has a thickness of about 5-95 percent of a total thickness of the insulation board.

13. The insulation board of claim 1, wherein the support layer comprises cement, acrylic, or combinations thereof.

14. The insulation board of claim 1, wherein the support layer comprises about 25 weight percent cement and about 75 weight percent acrylic, based on the total weight of the support layer.

15. The insulation board of claim 13, wherein the cement is Portland cement.

16. The insulation board of claim 1, wherein the support layer has a thickness of about 0.1-2 inches.

17. The insulation board of claim 1, comprising a yield tensile strength of at least about 5,000-10,000 psi in accordance with ASTM C1583.

18. A method of constructing the insulation board of claim 1, the method comprising:
forming the interior foam core through extrusion or expansion;
forming an angled top edge in the foam core;
forming a groove in the foam core;
applying the exterior support layer such that it surrounds the interior foam core; and
allowing the exterior support layer to dry.

19. The method of claim 18 wherein the groove, angled top edge, or both are formed through thermosetting, casting, molding cutting, impressing, or embossing.

20. The method of claim 18, wherein the exterior support layer is applied by spray coating, dip coating, roller coating, brush coating, casting, the use of a mold, or combinations thereof.
